(19) United States
(12) Patent Application Publication
(10) Pub. No.: US 2002/0146146 A1
(43) Pub. Date: Oct. 10, 2002

(54) Using digital watermarks to facilitate counterfeit inspection and inventory management

(76) Inventors: Ronald S. Miolla, Wilsonville, OR (US); Mark Richard Mehall, Tualatin, OR (US); Neil E. Lofgren, White Salmon, WA (US)

Correspondence Address: DIGIMARC CORPORATION, 19801 SW 72ND AVENUE, SUITE 100, TUALATIN, OR, 97062, US

(21) Appl. No.: 09/924,402

(22) Filed: Aug. 7, 2001

Related U.S. Application Data
(60) Provisional application No. 60/282,205, filed on Apr. 6, 2001.

(51) Int. Cl. G06K 9/00

(52) U.S. Cl. 382/100

(57) ABSTRACT

The present invention relates to an anti-counterfeiting and inventory management system. The backbone of the system is a digital watermark. Merchandise includes a digital watermark having an identifier, which is used to link to information regarding the merchandise. Inspectors test merchandise for an embedded watermark. The absence of a watermark alerts the inspector to a potential counterfeited item. The inspector can record inspection details in the database. In another embodiment, a digital watermark-based system is used to track inventory as it moves in distribution channels.

### RELATED APPLICATION DATA

This application is related to assignee's U.S. Provisional Patent Application No. 60/282,205, filed Apr. 6, 2001, and U.S. patent application Nos. 09/503,881, filed Feb. 14, 2000 and 09/571,422, filed May 15, 2000.

### FIELD OF THE INVENTION

The present invention relates to digital watermarking systems and methods, and is particularly illustrated with respect to an inspector network.

### BACKGROUND AND SUMMARY OF THE INVENTION

Counterfeiting—a process by which unauthorized copies are passed off as genuine—runs seemingly unchecked in today's global markets. Counterfeiting carries a heavy toll, frequently causing lost business sales and diminished goodwill. Companies may even become subjected to unwarranted product liability suits caused by below standard, knock-off products.

Yet it is the consumer who bares the brunt of counterfeiting. Many consumers purchase sub-par goods thinking that they are genuine, while unknowingly risking health or safety in the process. The bigger economic lose to the consumer is paying for a poor performing product. Consumers also typically end up paying higher prices for genuine goods, passed on by companies to offset counterfeiting losses.

Popular counterfeited items include software, music, videos, apparel, footwear, perfumes, watches, pharmaceuticals, etc.

Several factors underlie the proliferation of counterfeiting. First is ease of replication. Advances in technology have allowed for replication of near identical famous brand labels and tags, which are applied to cheaply made replica products. These knock-off replicas are sold at below market prices yielding a substantial return to the counterfeiter. Second is difficulty of detection. Sophisticated counterfeits routinely fool consumers. Independent (e.g., not directly working for a manufacturer) inspectors struggle to discern an original from a counterfeit. As a result, an inspection process clogs distribution channels, increases costs, and is often times ineffective. In a larger sense, the issue is more of logistics in terms of finding counterfeits (e.g., the cost of regular inspection) and enforcing the local country laws.

An efficient solution is needed to combat counterfeiting.

Digital watermarking can be used as part of this solution. Digital watermarking technology is a form of steganography, which encompasses a great variety of techniques by which plural bits of digital data are hidden in some other object, preferably without leaving human-apparent evidence of alteration.

Digital watermarking may be used to modify media content to embed a machine-readable code into the media content. The media may be modified such that the embedded code is imperceptible or nearly imperceptible to the user, yet may be detected through an automated detection process.

Most commonly, digital watermarking is applied to media signals such as images, audio, and video signals. However, it may also be applied to other types of media and objects including documents (e.g., through line, word or character shifting, through texturing, graphics, or backgrounds, through bit manipulation on printed materials, etc.), software, multi-dimensional graphics models, surface textures of objects, price tags, clothing tags, merchandise tags, and other physical objects such as packaging, product instructions, invoices, holographic images, and so forth. For consistency, media signals, documents and other physical objects will be hereafter referred to as “content.”

There are many processes by which content can be processed to encode a digital watermark. Some techniques employ very subtle printing, e.g., of fine lines or dots, which has the effect slightly tinting the content (e.g., a white media can be given a lightish-green cast). To the human observer the tinting appears uniform. Computer analyses of scan data from the content, however, reveals slight localized changes, permitting a multi-bit watermark payload to be discerned. Such printing can be by ink jet, dry offset, wet offset, xerography, etc.

The encoding of a document can encompass artwork or printing on the document, the document's background, a laminate layer applied to the document, surface texture, etc. If a photograph or image is present, it too can be encoded.

Printable content is increasingly fashioned from synthetic materials. Polymeric films, such as are available from UCB Films, PLC of Belgium, are one example. Such films may be clear and require opacification prior to use as substrates for security documents. The opacification can be affected by applying plural layers of ink or other material, e.g., by gravure or offset printing processes. (Suitable inks are available, e.g., from Sicpa Securink Corp. of Springfield, Va.). In addition to obscuring the transparency of the film, the inks applied through the printing process form a layer that is well suited to fine-line printing by traditional intaglio methods. Such an arrangement is more particularly detailed in laid-open PCT publication WO98/33758.

Digital watermarking systems typically have two primary components: an embedding component that embeds the watermark in the content, and a reading component that detects and reads the embedded watermark. The embedding component embeds a watermark pattern by altering data samples of the content. The reading component analyzes content to detect whether a watermark pattern is present. In applications where the watermark encodes information, the reading component extracts this information from the detected watermark. Previously mentioned U.S. Patent Application No. 09/503,881, filed Feb. 14, 2000, discloses various encoding and decoding techniques. United States Patent Nos. 5,862,260 and 6,122,403 disclose still others. Of course, artisans know many other watermarking techniques that may be suitably interchanged with the present invention.

One form of digital watermarks is a so-called “fragile” digital watermark. A fragile watermark is designed to be lost, or to degrade predictably, when the data set into which it is embedded is processed in some manner, such as signal processing or scanning/printing, etc. A watermark may be made fragile in numerous ways. One form of fragility relies on low watermark amplitude. That is, the strength of the watermark is only marginally above the minimum needed for detection. If any significant fraction of the signal is lost, as typically occurs in photocopying operations, the watermark becomes unreadable. Another form of fragility relies on the watermark's frequency spectrum. High frequencies are typically attenuated in the various sampling operations associated with digital scanning and printing. Even a high amplitude watermark signal can be significantly impaired, and rendered unreadable, by such photocopying operations. (Fragile watermark technology and various applications of such are even further disclosed, e.g., in assignee's U.S. patent application Nos. 09/234,780, 09/433,104, 09/498,223, 60/198,138, 09/562,516, 09/567,405, 09/625,577, 09/645,779, 09/898,901, and 60/232,163.).

The present invention discloses systems and methods by which merchandise (or a tag, label, packaging, box, shipping invoice, etc. associated with the merchandise) is digitally watermarked. Merchandise is monitored and tracked via the embedded watermark. Inspectors and custom agents ascertain counterfeits by the absence or misapplication of a digital watermark—greatly simplifying an inspection process.

The foregoing and other features and advantages of the present invention will be more readily apparent from the following detailed description, which proceeds with reference to the accompanying drawings.

### BRIEF DESCRIPTION OF THE DRAWINGS

FIG. 1 is a functional block diagram illustrating digitally watermarking merchandise.

FIG. 2 is a diagram of an inspector network according to the present invention.

FIG. 3 is a screenshot of a graphical user interface (GUI) for use with the network illustrated in FIG. 2.

FIG. 4 is another screen shot of a graphical user interface (GU I for use with the network illustrated in FIG. 2.

### DETAILED DESCRIPTION

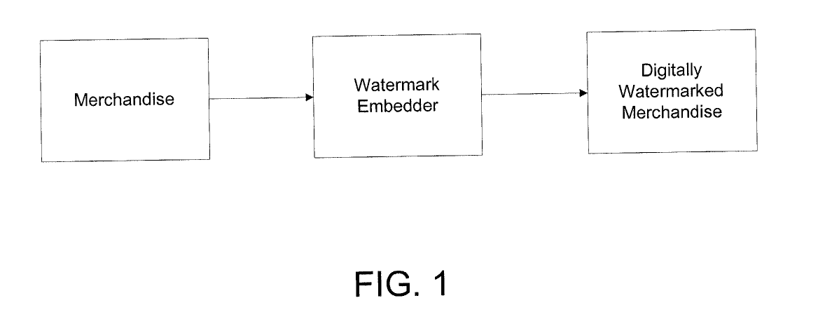

This application discloses a solution to manage merchandise and to combat counterfeiting. Merchandise is digitally watermarked, as shown in FIG. 1. Merchandise can be directly watermarked , e.g., by embedding a digital watermark in a design, text, picture, graphic, background or logo to be applied to merchandise. Alternatively, merchandise can be indirectly watermarked by embedded a digital watermark in a product tag, price tag, label, product packaging, box, wrapping, invoice, etc. that is associated with the merchandise. Of course, merchandise is broadly defined and includes items such as shoes, other footwear, software, music, CDs, tapes, videos, DVDs, clothing, other apparel, computer and peripheral products, sporting goods and equipment, electronic products and goods, consumer products, electronic components, automobiles and automobile parts, hardware, baby food and formula, consumable products, household and yard furnishings, household goods, replacement parts, cleaning supplies, value documents, etc., etc. Of course this is not an exhaustive list.

A digital watermark can be viewed as an information signal that is embedded in a host signal, such as a texture, background, picture, graphic, logo, text, artwork, design, image, audio, video or some other content. To embed a message, the watermark encoder analyzes and selectively adjusts the host signal to give it attributes that correspond to a desired message symbol or symbols to be encoded. There are many signal attributes that may encode a message symbol, such as a positive or negative polarity of signal samples or a set of samples, a given parity (odd or even), a given difference value or polarity of the difference between signal samples (e.g., a difference between selected spatial intensity values or transform coefficients), a given distance value between watermarks, a given phase or phase offset between different watermark components, a modulation of the phase of the host signal, a modulation of frequency coefficients of the host signal, a given frequency pattern, a given quantizer (e.g., in Quantization Index Modulation), etc.

The structure and complexity of a watermark signal can vary significantly, depending on the application. For example, the watermark may be comprised of one or more signal components, each defined in the same or different domains. Each component may perform one or more functions. Two primary functions include acting as an identifier to facilitate detection and acting as an information carrier to convey a message. In addition, components may be located in different spatial or temporal portions of the host signal, and may carry the same or different messages.

The host signal can vary as well. The host is typically some form of multi-dimensional content signal. In the digital domain, each of these content types is represented as a multi-dimensional array of discrete samples. For example, a color image has spatial dimensions (e.g., its horizontal and vertical components), and color space dimensions (e.g., CMYK, YUV or RGB). Some signals, like video, have spatial and temporal dimensions. Depending on the needs of a particular application, the embedder may insert a watermark signal that exists in one or more of these dimensions.

Various forms of statistical analyses may be performed on a signal to identify places to locate the watermark, and to identify places where to extract the watermark. For example, a statistical analysis can identify portions of a host image that have noise-like properties that are likely to make recovery of the watermark signal difficult. Similarly, statistical analyses may be used to characterize the host signal to determine where to locate the watermark.

Each of the techniques may be used alone, in various combinations, and in combination with other signal processing techniques.

A digital watermark preferably includes a message “payload” or other information bits (e.g., 8-512 bits). The payload can be used to carry a unique identifier, a product identifier, a manufacture identifier, and/or an index to retrieve additional information. Consider the following cases. In a first case, the payload uniquely identifies an individual article of merchandise. The payload conveys manufacturing details, such as batch, location and/or date of manufacture. Alternatively, the payload identifies the brand, company, owner, product family, and/or licensee, etc. In a second case, the payload includes an identifier, which is operable as a database index. This identifier is used to interrogate a database. The database stores information (e.g., a data record) related to the subject merchandise. Such information may include date and place of manufacture, description of the subject merchandise, shipping destination, shipping history, description of shipping channel, batch processing information (e.g., a batch of 20,000), owner, purchaser, associated trademarks, inspection instructions, payment instructions, and/or inspector comments.

### System Description

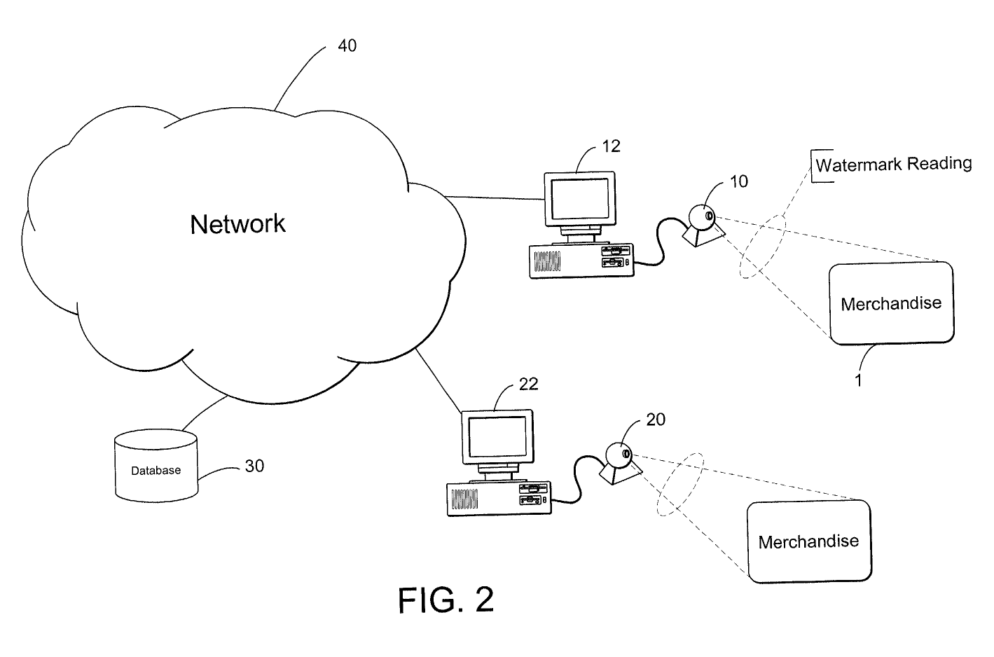

An inspector system is now described with reference to FIG. 2. An input device 10 captures an image of merchandise 1. Merchandise 1 includes a digital watermark embedded therein. As discussed above, merchandise 1 can be directly or indirectly watermarked. Input device 10 preferably includes a digital camera, web cam, optical scanner, optical capture device, CMOS camera, camera-on-a-chip, a digital eye, and/or an electrical sensor. Input device 10 communicates a captured image to personal computer 12. Although input device 10 is illustrated as being tethered to personal computer 12, it need not be so. Instead, input device 10 can wirelessly communicate with personal computer 12. Or input device 10 can be integrated with personal computer 12 or periodically interface with computer 12.

Personal computer 12 is preferably a general-purpose computer having computer software instructions stored in memory for execution on its processor. In particular, computer 12 includes digital watermark detection and decoding software stored therein. Computer 12 preferably includes an interface, e.g., such as a web browser, inspector input software or other communication software. Of course, computer 12 can be a handheld computer, laptop, processor module, dedicated electronic circuitry, or other mobile computing device.

The digital watermark decoding software analyzes the captured digital image to recover a digital watermark payload. In one embodiment, the message payload includes an identifier, which is communicated through network 40 to database 30. The identifier is used to interrogate database 30 to retrieve related information. Of course, network 40 can be an extranet, internet, wireless network, LAN, WAN, etc. A server or general-purpose computer maintains database 30. Computer 12 can maintain continuous communication with network 40 or may periodically (or sporadically) communicate with such. (In an alternative embodiment, computer 12 communicates directly with database 30, instead of communicating via network 40.). The database server includes software instructions, e.g., for database management, web pages, communication, etc.

The FIG. 2 system optionally includes additional inspector stations, such as computer station 22 and associated input device 20. The additional inspector stations can be distributed and/or may be physically located in the local area.

### System Operation

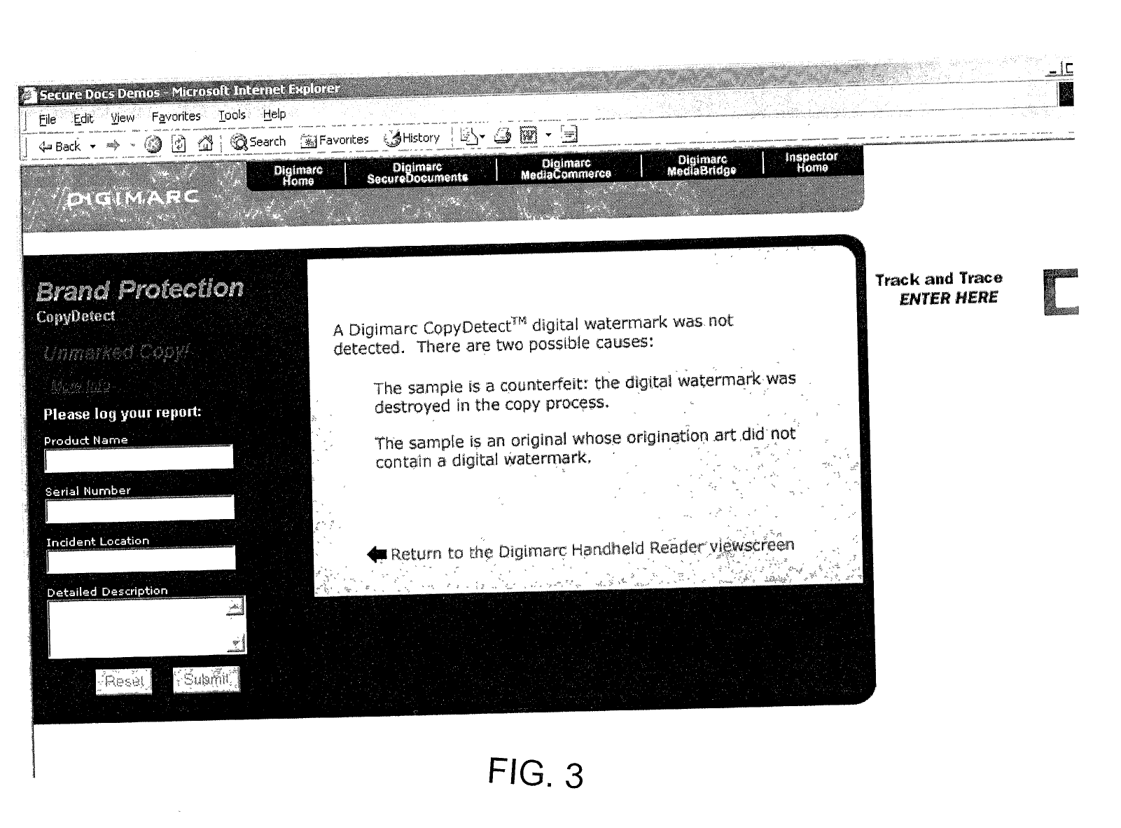

With reference to FIG. 3, an inspector preferably interacts with database 30 via a set of web pages or other graphical user interface (GUI). An inspector initiates an inspection session in a number of alternative ways. In a first alternative, an inspector presents a digitally watermarked PortalCard™ to input device 10. (See assignee's co-pending U.S. Patent Application No. 09/790,322 for additional details regarding secure authentication using a PortalCard™). A digital image of the PortalCard™ is captured and conveyed to computer 12. Digital watermark decoding software executing on computer 12 decodes the digital watermark. The watermark includes a code (or identifier), which is used to direct computer 12's web browser to the server/database 30. In some embodiments, a routing server (not shown) identifies an appropriate URL or network address (for the server/database 30) with the decoded identifier, and supplies the URL or network address to the web browser. In another embodiment, computer 12's web browser defaults to database 30's address. In still another embodiment, the server/database 30 is accessed and a PortalCard™ is presented as part of a login process. In this case, the PortalCard™ includes an identifier, which is used to authenticate an inspector. The PortalCard™ can be used in connection with a PIN or password to provide additional security. Other digital watermark-to-web page linking can be provided, e.g., via Digimarc's MediaBridge line of products and services. (MediaBridge software is available at www.digimarc.com or through Digimarc in Tualatin, Oreg. USA.).

Alternatively, an inspector accesses the database 30 in a conventional manner, e.g., linking or typing the appropriate database address; Or by establishing a direct or secure communications link with server/database 30. Inspector identity can be verified via a conventional username/password.

An inspector is preferably prompted to initiate an inspection session. Such a session typically includes presenting merchandise to input device 10. Computer 12 searches a captured image for an embedded watermark. A counterfeit is suspected when a digital watermark is not found (e.g., a false test). If a watermark is not found, the inspector is presented with a graphical user interface (GUI) or web page to report the incident. (See FIG. 3). If a fragile watermark is embedded in an original tag or label, the absence of a digital watermark may indicate that the tag is a copy. In another embodiment, a false test may also indicate either a counterfeit or that the merchandise is an original but was not digitally watermarked. In this case, the merchandise can be subjected to further inspection. Another trigger for product inspection can be a third party (e.g., customs, retailer, etc.) that suspects counterfeits or product diversion, which notifies a company inspector to do forensic analysis of the suspected counterfeit situation.

The inspector logs the results to the database 30 via a GUI. For example, the inspector may indicate the product's name, the product serial number (if any), inspection location, and any further comments (See FIG. 3).

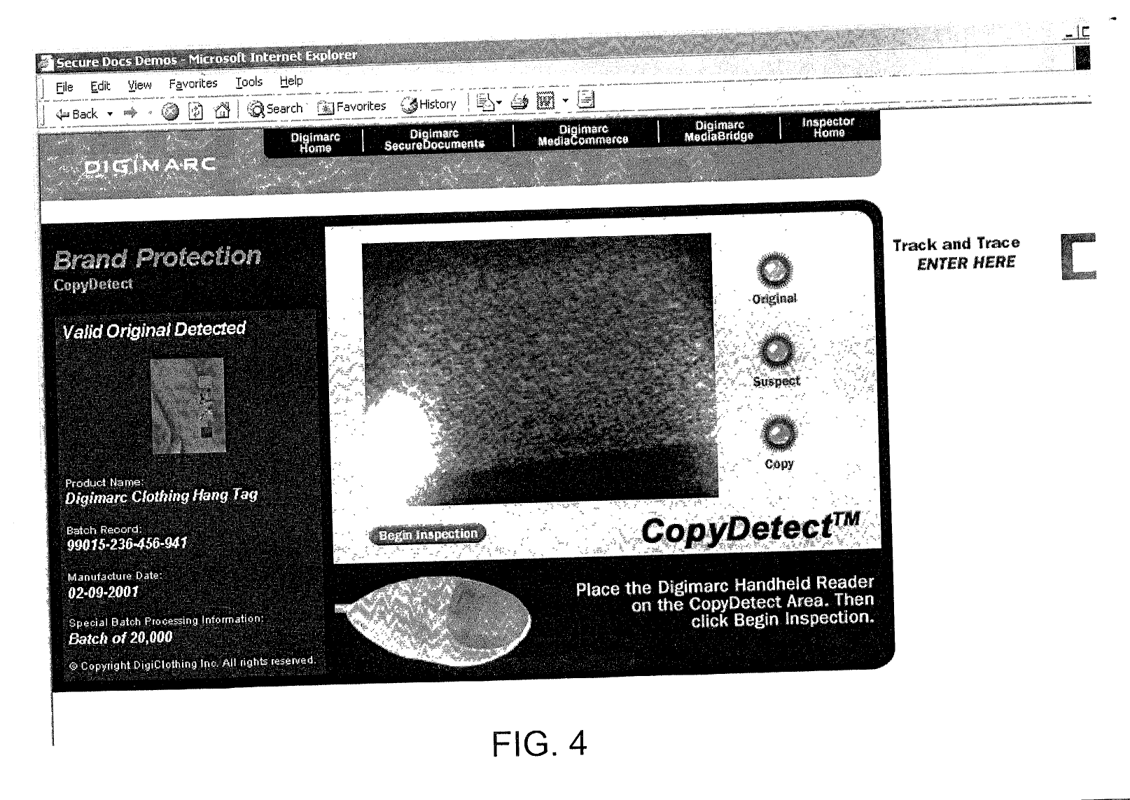

If a watermark is found, the digital watermark decoding software extracts the payload. The payload preferably includes an identifier (or index) as discussed above. The identifier is used to interrogate database 30 to retrieve any associated information. Such information may include the product's name, batch record (e.g., identifier), manufacture date, destination information, shipping history, etc. This information may be conveyed to the inspector's computer 12 from the database for display via a GUI (see FIG. 4). This information can be used to determine counterfeits.

Consider a situation where a counterfeiter has stolen or copied digitally watermarked product tags or labels, which are then applied to counterfeited goods. The watermark detector detects a watermark and retrieves information from the database 30. This information is then compared against the actual merchandise. In an “easy” case, the information tells the inspector that she has just inspected, e.g., a pair of running shoes, when the inspector actually has inspected a tennis racket. In other cases, shipping or destination information may conflict with actual information. Or the delivery and/or manufacture data may tip-off an inspector that she is dealing with a counterfeited item.

Results from a successful inspection, e.g., finding a digital watermark and successfully matching retrieved data to actual goods, are preferably logged in the database 30. An inspection record is thus created and maintained.

Such a system may be used to track merchandise as it travels in distribution and/or inspection channels. Consider a typical merchandise routing process at a distribution hub. Merchandise is read to determine a digital watermark payload. An index is extracted from the payload and is conveyed to the database 30. Once the corresponding data is retrieved, the distribution hub determines the appropriate location or time to route the merchandise. For example, the returned data may indicate that the subject merchandise should be sent to Hong Kong by next Tuesday. The distribution hub's transaction (e.g., inspection, handling, packing, shipment, routing, etc.) can be recorded in the database. Thus, an efficient tracking system is created, which relies on a digital watermark as a merchandise identifier.

Database 30 can be constructed using commercial database software, e.g., such as provided by Oracle, Microsoft, or Sun Microsystems, etc., running on a computer or server. Alternatively, a database can be custom designed to meet a particular customer's needs. In either case, the database preferably organizes merchandise by associating identifiers with the merchandise. Merchandise can be organized according to individual items, product manufacturing batches, owner, etc. Such information is linked (or associated) with the watermark index or identifier. The identifier is embedded with the digital watermark.

In some cases, a digital watermark payload will include both a database identifier and a merchandise identifier. The database identifier identifies the appropriate database or library, while the merchandise identifier identifies the appropriate data record. A manufacturer can populate database 30 when goods are produced and/or tagged. Alternatively, a quality assurance team, which manages inventory and merchandise for a particular inspection system, populates database 30. Or population occurs when the inventory reaches a distribution channel. Inspectors and distribution hubs also populate database 30 during the inspection and distribution processes discussed above.

### Alternative Embodiments

In an alternative embodiment, computer 12 is a mobile computer. An inspector remotely reads a plurality of merchandise items. The reads are stored in computer 12. Thereafter, the inspector establishes communication with the database 30. Each of the stored plurality of merchandise items is compared against database 30 entries.

In yet another embodiment, an inspector downloads a replica or a subset of the database 30 onto computer 12 (or to a local storage site). The inspector then inspects goods as discussed above. However, the database comparison is conducted locally, without external network communication. Computer 12 periodically (or sporadically) communicates with database 30 to convey results and to receive database updates.

In still another embodiment, both a fragile watermark and a robust watermark are embedded in a merchandise tag (or label). The absence or degradation of the fragile watermark evidences a counterfeit, while the robust watermark allows retrieval of identifying information.

### Concluding Remarks

The foregoing are just exemplary implementations of the present invention. It will be recognized that there are a great number of variations on these basic themes. The foregoing illustrates but a few applications of the detailed technology. There are many others.

The section headings in this application are provided merely for the reader's convenience, and provide no substantive limitations. Of course, the disclosure under one section heading may be readily combined with the disclosure under another section heading.

The above-described systems and methods are also effective to combat product diversion of legitimate product into channels that are not authorized. In particular, the tracking system discussed above can be employed to monitor the flow of legitimate products through distribution channels. Another benefit is to combat the production of overruns (e.g., production at an authorized plant without company permission) that are then sold without authorization or revenue to the brand owner. In some cases manufacturing is subcontracted out to a third party who produces product in volumes higher than authorized and resells it. Another monitoring embodiment of the present invention is to control, detect and/or monitor the misuse of original packaging art applied to counterfeit product.

To provide a comprehensive disclosure without unduly lengthening this specification, the above-mentioned patents and patent applications are hereby incorporated by reference. The particular combinations of elements and features in the above-detailed embodiments are exemplary only; the interchanging and substitution of these teachings with other teachings in this application and the incorporated-by-reference patents/applications are also expressly contemplated.

The above-described methods and functionality can be facilitated with computer executable software stored on computer readable media, such as electronic memory circuits, RAM, ROM, magnetic media, optical media, memory sticks, hard disks, removable media, etc., etc. Such software may be stored and executed on a general-purpose computer, or on a server for distributed use. Also, instead of software, a hardware implementation, or a software-hardware implementation can be used.

In view of the wide variety of embodiments to which the principles and features discussed above can be applied, it should be apparent that the detailed embodiments are illustrative only and should not be taken as limiting the scope of the invention. Rather, we claim as our invention all such modifications as may come within the scope and spirit of the following claims and equivalents thereof.

What is claimed is:

1. A method to identify counterfeit merchandise comprising the steps of:
inspecting merchandise for a digital watermark; and
identifying counterfeit merchandise by the absence of a watermark.

2. The method according to claim 1, wherein the digital watermark includes an identifier, said method further comprising a step of accessing information with the identifier.

3. The method according to claim 2, further comprising a step of identifying a counterfeit through comparison of the merchandise with the assessed information.

4. The method according to claim 3, wherein the digital watermark comprises a fragile watermark, and wherein the absence of a watermark comprises a degradation of the fragile watermark.

5. An inspector network comprising:
a database comprising a plurality of entries, at least one of the entries including merchandise information;
an inspector computer comprising:
an input device to capture an image of merchandise;
a computer including electronic processing circuitry and electronic memory circuitry, wherein said electronic memory circuitry has computer executable instructions stored thereon, said instructions including instructions to:
detect a digital watermark in an image captured by said input device;
decode a detected watermark, the watermark including at least plural information bits; and to
request information from said database corresponding to the plural information bits; and
a network interface to communicate with said database.

6. The inspector network according to claim 5, wherein said inspector computer generates a signal when a digital watermark is not detected by said computer executable detect instructions.

7. The inspector network according to claim 5, further comprising computer executable instructions stored in said electronic memory circuits to generate a graphical user interface.

8. A method to track inventory or product tags comprising the steps of:
embedding a digital watermark in merchandise, the digital watermark including at least one identifier;
establishing a data record to be indexable according to the at least one identifier; and
updating the data record to reflect inventory status.

9. The method according to claim 8, wherein the digital watermark is embedded directly on the merchandise.

10. The method according to claim 8, wherein the digital watermark is embedded in at least one of a merchandise tag, label, invoice, shipping instructions, and packaging.

11. The method according to claim 8, wherein the inventory status comprises at least one of current location, shipping history, destination information, handling instructions, customs information, inspector instructions, batch number, manufacture information, and shipping dates.
